(19) United States
(12) Patent Application Publication
(10) Pub. No.: US 2008/0306190 A1
(43) Pub. Date: Dec. 11, 2008

(54) Composition of matter based on alkyl benzyl esters

(76) Inventors: Thomas Weiss, Ilvesheim (DE); Eberhard Kuckert, Leverkusen (DE); Melanie Wiedemeier, Dormagen-Delhoven (DE); Jan-Gerd Hansel, Bergisch Gladbach (DE)

Correspondence Address: LANXESS CORPORATION, 111 RIDC PARK WEST DRIVE, PITTSBURGH, PA, 15275-1112, US

(21) Appl. No.: 12/148,206

(22) Filed: Apr. 17, 2008

(30) Foreign Application Priority Data
Apr. 21, 2007 (DE) 10 2007 018 992.5

(51) Int. Cl. C08K 5/521; C08K 5/10; C09K 3/00; C08K 5/42

(52) U.S. Cl. 524/131; 524/288; 524/296; 524/289; 252/182.28

(57) ABSTRACT

The present invention relates to ester mixtures composed of alkyl benzyl esters and of polybenzyl esters, in particular of trimellitic esters, to a process for preparation of these ester mixtures, and also to their use as plasticizers.

The present invention relates to ester mixtures composed of alkyl benzyl esters and of polybenzyl esters, to a process for preparation of these ester mixtures, and also to their use as plasticizers.

### BACKGROUND OF THE INVENTION

For decades, plasticizers have been used for processing plastics, such as polyvinyl chloride. Recently, the requirements placed upon the plasticizers have become more stringent with respect to performance and non-toxicity to humans and the environment. One important requirement relates to minimum solution temperature. Solution temperature in the context of plasticizers is the temperature at which a homogeneous phase is formed from a polyvinyl chloride dispersion in a plasticizer (L. Meier: “Weichmacher” [“Plasticizers”], in R. Gächter, H. Müiller (Ed.): Taschenbuch der Kunststoffadditive [Plastics additives handbook], 3rd Edition, pp. 361-362, Hanser Verlag, Munich 1990). Plasticizers with a low solution temperature permit fast processing that saves energy.

In the prior art, applications which require a low solution temperature mainly use alkyl benzyl esters of aromatic polycarboxylic acids, an example being butyl benzyl phthalate (L. Meier: “Weichmacher” [“Plasticizers”], in R. Gächter, H. Müller (Ed.): Taschenbuch der Kunststoffadditive [Plastics additives handbook], 3rd Edition, p. 397, Hanser Verlag, Munich 1990). These can be prepared at low cost via reaction of aliphatic alcohols with aromatic polycarboxylic acids or with their cyclic anhydrides and benzyl halides, e.g. benzyl chloride, in the presence of a base. The preparation process can be carried out in steps or by a one-pot method (DE-A 1 468 373 for benzyl alkyl phthalates, DE-A 1 593 047 for benzyl alkyl trimellitates).

Further, low volatility is also demanded, alongside a low solution temperature, from modern plasticizers. Volatility of plasticizers leads to undesired embrittlement of plasticized polyvinyl chloride, and also to pollution by what are known as volatile organic compounds (VOCs), which are undesirable in consumer applications.

Butyl benzyl phthalate has a very low solution temperature, but is volatile. Commercially available trialkyl trimellitates, e.g. trioctyl trimellitate or Uraplast® 525 (C₈-C₁₀-trialkyl trimellitate derived from linear C₈-C₁₀ alcohols) have high solution temperatures but low volatility.

DE-A 1 593 047 describes the preparation of n-butyl dibenzyl trimellitate via esterification of a mixture composed of trimellitic anhydride, n-butanol and benzyl chloride in the presence of stoichiometric amounts of triethylamine, and its use as plasticizer. The use of stoichiometric amounts of triethylamine is attended by disadvantages The ammonium salt formed in the reaction from the triethylamine passes, during aqueous work-up of the reaction mixture, into the wastewater where, because its amount is large, it generates sizable carbon loadings and nitrogen loadings. Complicated purification of the wastewater is therefore required. It is moreover known that some of the benzyl chloride used reacts with the triethylamine to give triethylbenzylammonium chloride, the final destination of which is likewise the wastewater. The result is therefore loss not only of the valuable amine but also of some of the benzyl chloride.

The object of the present invention consisted in providing plasticizers with low solution temperature and with low volatility which can be prepared easily and without use of stoichiometric amounts of organic amines.

### SUMMARY OF THE INVENTION

Surprisingly, unexpectedly low solution temperatures together with low volatility and particularly easy preparation have now been found for esters mixtures composed of alkyl benzyl esters of aromatic tri- and tetracarboxylic acids and for polybenzyl esters of aromatic tri- and tetracarboxylic acids. This invention provides esters mixture comprising

a) from 80 to 99% by weight of one or more esters of the structure (R¹OOC)ₘ-Z-(COOR²)ₚ
b) from 1 to 20% by weight of an ester of the structure (R²OOC)ₘ-Z
where the total of the % by weight values derived from the components of the ester mixtures is 100 and in which
R¹ is a straight-chain or branched C₁-C₂₀-alkyl moiety,
R² is a benzyl moiety optionally substituted with C₁-C₄-alkyl or with halogen,
Z is an m-valent aromatic C₆-C₁₀-hydrocarbon moiety,
m is a number from 3 to 4 and
each of n and p is a number from 1 to 3, with the proviso that n+p=m.

It is preferable that R¹ is n-butyl, 2-ethylhexyl or isononyl.

It is preferable that R² is benzyl (—CH₂-Ph).

It is preferable that the moiety Z derives structurally from pyromellitic acid or trimellitic acid.

In one particularly preferred embodiment of the invention, the esters of the structure (R¹OOC)ₙ-Z-COOR²)ₚ are butyl dibenzyl trimellitate or dibutyl benzyl trimellitate and the ester of the structure (R²OOC)ₘ-Z is tribenzyl trimellitate.

The inventive ester mixtures can be prepared via mixing of the components known per se in the stated ratio. However, they are preferably prepared via a mixed esterification reaction. The invention therefore also provides a process for preparation of the mixtures of alkyl benzyl esters of aromatic tri- or tetracarboxylic acids with polybenzyl esters of aromatic tri- or tetracarboxylic acids, which comprises at least one aromatic tri- or tetracarboxylic acid or a derivative thereof, at least one benzyl halide and at least one aliphatic alcohol are reacted with one another at temperatures of from 50 to 300° C. and at pressures of from 2 mbar to 4 bar in the presence of an inorganic base and of a substoichiometric amount of a phase-transfer catalyst.

The process can be carried out in one step or in two steps. In the case of conducting one step, all of the reactants are brought into contact with one another in essence simultaneously, and reacted. In the case of conducting two steps, it is preferable that, in a first step, the aromatic tri- or tetracarboxylic acid or a derivative thereof is reacted with the aliphatic alcohol, and that a reaction mixture thus obtained is reacted, in a second step, with the benzyl chloride, with the inorganic base and with the phase-transfer catalyst.

Irrespective of whether the process is carried out in one step or in two steps, it can be carried out batchwise or continuously. The reaction mixture can be diluted with a solvent. The reaction described above can be followed by purification operations familiar to the person skilled in the art, e.g. extraction, in particular aqueous wash, distillation, including steam distillation, adsorption, and/or filtration.

If a tricarboxylic acid is used, the molar amounts of the starting materials, based on 1 mol of the tricarboxylic acid or of the tricarboxylic acid derivative are preferably from 1.7 to 2.3 mol of benzyl chloride, from 0.7 to 1.3 mol of aliphatic alcohol, from 0.4 to 2.5 mol of inorganic base and from 0.01 to 0.3 mol of phase-transfer catalysts. If a tetracarboxylic acid is used, the molar amounts of the starting materials, based on 1 mol of the tetracarboxylic acid or of the tetracarboxylic acid derivative are preferably from 2.7 to 3.3 mol of benzyl chloride, from 0.7 to 1.3 mol of aliphatic alcohol, from 1.4 to 3.5 mol of inorganic base and from 0.01 to 0.4 mol of phase-transfer catalysts.

The inventive process may use the aromatic tri- or tetracarboxylic acid per se or in the form of a derivative, for example in the form of an anhydride, ester, or acyl chloride. One preferred embodiment of the invention uses the tri- or tetracarboxylic acids and/or their anhydrides.

The reactants used in the inventive process are, as mentioned above, (1) aromatic tri- or tetracarboxylic acids or their anhydrides, (2) benzyl chlorides, (3) monohydroxy aliphatic alcohols, (4) inorganic bases and (5) phase-transfer catalysts. A detailed description of these reactants follows:

Preferred tri- or tetracarboxylic acids to be used according to the invention are benzene-1,2,3-tri-carboxylic acid, benzene-1,2,4-tricarboxylic acid (trimellitic acid), benzene-1,2,3,4-tetracarboxylic acid, benzene-1,2,3,5-tetracarboxylic acid or benzene-1,2,4,5-tetracarboxylic acid (pyromellitic acid) or the anhydrides of the acids mentioned. Particularly preferred anhydrides are trimellitic anhydride and pyromellitic anhydride. For the purposes of the inventive process, the anhydride can be added to a reaction zone and take the form, for example, of melt, of solid, e.g. flakes, of solution, or of dispersion.

Preferred benzyl halides that may be mentioned for use according to the invention are benzyl chloride, benzyl bromide, alkyl-substituted benzyl chlorides or benzyl bromides, and also alkoxy-substituted benzyl chlorides or halogen-substituted benzyl chlorides. It is particularly preferable to use benzyl chloride, methylbenzyl chloride, ethylbenzyl chloride, dimethylbenzyl chloride, methoxybenzyl chloride, ethoxybenzyl chloride, chlorobenzyl chloride, dichlorobenzyl chloride, trichorobenzyl chloride, bromobenzyl chloride, dibromobenzyl chloride or the like.

Alcohols to be used according to the invention are monohydric aliphatic alcohols, such as methyl alcohol, ethyl alcohol, propyl alcohol, isopropyl alcohol, butyl alcohols, e.g. n-butyl alcohol and sec-butyl alcohol, isobutyl alcohol, amyl alcohol, hexyl alcohols, e.g. n-hexyl alcohol, 1,4-dimethylbutyl alcohol, n-heptyl alcohol, octyl alcohols, e.g. isooctyl alcohols, n-octyl alcohol, 2-ethylhexyl alcohol, n-nonyl alcohol, isononyl alcohols, decyl alcohols, e.g. n-decyl alcohol, isodecyl alcohol, dodecyl alcohol, tridecyl alcohol, tetradecyl alcohol, pentadecyl alcohol, cetyl alcohol, octadecyl alcohol, and eicosyl alcohol; cycloaliphatic alcohols, e.g. cyclopropylcarbinol, cyclobutyl alcohol, cyclopentyl alcohol, methylcyclopentyl alcohol, dimethylcyclopentyl alcohol, ethylcyclopentyl alcohol, cyclohexyl alcohol, methylcyclohexyl alcohol, dimethylcyclohexyl alcohol and cyclooctyl alcohol; and unsaturated aliphatic alcohols, e.g. allyl alcohol, crotyl alcohol and the like. All of the various isomeric forms of these alcohols and mixtures of the same are moreover suitable for use in the inventive process. The source of the alcohol does not moreover effect the process, and it is therefore possible, for example, to use aliphatic alcohols which come from one- or two-stage oxo processes, from the hydration of olefins or from the catalytic dehydrogenation of coconut oil, these alcohols in fact being desirable because of their availability.

Inorganic bases to be used according to the invention are oxides, hydroxides, phosphates, hydrogenphosphates, carbonates, hydrogencarbonates and silicates of the alkali metals and of the alkaline earth metals. It is preferable to use lithium carbonate, lithium hydrogencarbonate, sodium carbonate, sodium hydrogencarbonate, potassium carbonate, potassium hydrogencarbonate, magnesium carbonate, calcium carbonate, magnesium hydroxide, calcium hydroxide, magnesium oxide or calcium oxide. The inorganic bases are particularly preferred used in their anhydrous form, an example being sodium carbonate.

Any of the known phase-transfer catalysts is suitable for use in the inventive process. It is preferable to use quaternary organic ammonium salts, particularly tetra-n-butylammonium salts, N-cetyl-N,N,N-trimethylammonium salts, tetrabenzylammonium salts or triethylbenzylammonium salts.

It is very particularly preferable that the quaternary organic ammonium salts are generated in situ in the reaction mixture, by adding tertiary amines of structure

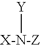

in which
X, Y and Z are identical or non-identical aliphatic moieties,
to the mixture. These amines react with the benzyl halide to give the catalytically active quaternary organic ammonium halides. For reasons of cost it is preferable that X, Y and Z are alkyl moieties. Non-restrictive examples of these trialiphatic amines are trimethylamine, triethylamine, tripropylamine, tri-n-butylamine, triisoamylamine, trihexylamine, methyldiethylamine, dimethylethylamine, dimethylcyclohexylamine, dimethylhexylamine, benzyldimethylamine, diethylhexylamine, diemethyldecylamine. Particular aromatic amines which may be mentioned are pyridine derivatives and imidazole derivatives, e.g. methylpyridine, N-methylimidazole, and in particular the parent compounds.

Finally, other compounds suitable for the phase-transfer catalysis for preparation of the abovementioned esters are crown ethers, such as 18-crown-6, and polyethylene glycols with molar masses of from 200 to 4000 g/mol.

The invention also encompasses the use of the ester mixtures as plasticizers for plastics, preferably for polyvinyl chloride, vinyl-chloride-based copolymers, polyvinylidene chloride, polyvinyl acetals, polyacrylates, polyamides, polylactides, cellulose and its derivatives, rubber polymers, such as acrylonitrile-butadiene rubber, hydrogenated acrylonitrile-butadiene rubber, chloroprene rubber, chlorinated polyethylene, chlorosulphonyl polyethylene, ethylene-propylene rubber, acrylate rubber and/or epichlorohydrin rubber. Particular preference is given to the use as plasticizer for polyvinyl chloride.

The polyvinyl chloride here is preferably prepared via homopolymerization from vinyl chloride by methods known to the person skilled in the art, e.g. suspension polymerization, emulsion polymerization or bulk polymerization. The inventive ester mixtures are preferably used in mixtures with from 20 to 99% of polyvinyl chloride, preferably from 45 to 95% of polyvinyl chloride, particularly preferably from 50 to 90% of polyvinyl chloride. These mixtures are termed plasticized polyvinyl chloride and can comprise not only the inventive ester mixtures and polyvinyl chloride but also other suitable additives. Examples of those that may be present are lubricants, fillers, pigments, flame retardants, light stabilizers and other stabilizers, blowing agents, polymeric processing aids, impact modifiers, optical brighteners, and antistatic agents, or biostabilizers.

The plastics also preferably comprise additives, such as lubricants, fillers, pigments, flame retardants, light stabilizers and other stabilizers, blowing agents, polymeric processing aids, impact modifiers, optical brighteners, and antistatic agents, and/or biostabilizers, or else a mixture thereof.

Some suitable additives are described in more detail below. However, the examples listed do not restrict the inventive mixtures but serve merely for illustration. All of the data relating to content are % by weight values.

Stabilizers neutralize the hydrochloric acid eliminated during and/or after processing of the polyvinyl chloride. Stabilizers that can be used are any of the conventional polyvinyl chloride stabilizers in solid or liquid form, for example conventional epoxy/zinc, Ca/Zn, Ba/Zn, Pb or Sn stabilizers, or else acid-binding phyllosilicates, such as hydrotalcite. The inventive ester mixtures can be used in mixtures whose content of stabilizers is from 0.05 to 7%, preferably from 0.1 to 5%, particularly preferably from 0.2 to 4% and in particular from 0.5 to 3%.

Lubricants are intended to act between the polyvinyl chloride particles and to counteract frictional forces during mixing, plastification and deformation. Lubricants that can be present in the inventive mixtures are any of the conventional lubricants for the processing of plastics. By way of example, it is possible to use hydrocarbons, such as oils, paraffins and PE waxes (PE=polyethylene), fatty alcohols having from 6 to 20 carbon atoms, ketones, carboxylic acids, such as fatty acids and montanic acids, oxidized PE wax, metal carboxylates, carboxamides, and also carboxylic esters, for example with the alcohols ethanol, fatty alcohols, glycerol, ethanediol, pentaerythritol and long-chain carboxylic acids as acid component. The inventive ester mixtures can be used in mixtures whose content of lubricants is from 0.01 to 10%, preferably from 0.05 to 5%, particularly preferably from 0.1 to 3% and in particular from 0.2 to 2%.

Fillers primarily have a favourable effect on compressive strength, tensile strength and flexural strength, and also the hardness and heat resistance of plasticized polyvinyl chloride or polyvinyl bromide. For the purposes of the invention, the mixtures can also comprise fillers, such as carbon black and other inorganic fillers, such as natural calcium carbonates, e.g. chalk, limestone and marble, synthetic calcium carbonates, dolomite, silicates, silica, sand, diatomaceous earth, aluminium silicates, such as kaolin, mica and feldspar. Fillers preferably used are calcium carbonates, chalk, dolomite, kaolin, silicates, talc or carbon black. The inventive ester mixtures can be used in mixtures whose content of fillers is from 0.01 to 80%, preferably from 0.1 to 60%, particularly preferably from 0.5 to 50% and in particular from 1 to 40%.

The mixtures prepared with the inventive ester mixtures can also comprise pigments, in order to match the resultant product to various possible uses. For the purposes of the present invention, it is possible to use either inorganic pigments or else organic pigments. Examples of inorganic pigments that can be used are cadmium pigments, such as CdS, cobalt pigments, such as CoO/Al₂O₃, and chromium pigments, such as Cr₂O₃. Organic pigments that can be used are monoazo pigments, condensed azo pigments, azomethine pigments, anthraquinone pigments, quinacridones, phthalocyanine pigments, dioxazine pigments and aniline pigments. The inventive ester mixtures can be used in mixtures whose content of pigments is from 0.01 to 10%, preferably from 0.05 to 5%, particularly preferably from 0.1 to 3% and in particular from 0.5 to 2%.

In order to reduce flammability and smoke generation during combustion, the inventive mixtures can also comprise flame retardants. Examples of flame retardants that can be used are antimony trioxide, phosphate esters, chloroparaffins, aluminium hydroxide, boron compounds, molybdenum trioxide, ferrocene, calcium carbonate or magnesium carbonate. The inventive ester mixtures can be used in mixtures whose content of flame retardant is from 0.01 to 30%, preferably from 0.1 to 25%, particularly preferably from 0.2 to 20% and in particular from 0.5 to 15%.

The mixtures can also comprise light stabilizers in order to protect items produced from a mixture comprising the inventive ester mixtures from damage in the region of the surface via the effect of light. For the purposes of the present invention, hydroxybenzophenones or hydroxyphenylbenzotriazoles can, be used, for example. The inventive ester mixtures can be used in mixtures whose content of light stabilizers is from 0.01 to 7%, preferably from 0.1 to 5%, particularly preferably from 0.2 to 4% and in particular from 0.5 to 3%.

The plastics preferably also comprise further plasticizers, such as monoalkyl esters of benzoic acid, benzoic diesters of mono-, di-, tri- or polyalkylene glycols, dialkyl esters of aliphatic diacids, dialkyl esters of aromatic diacids, trialkyl esters of aromatic triacids, phenyl esters of alkanesulphonic acids, alkyl or aryl esters of phosphoric acid, polyesters derived from dicarboxylic acids, or else a mixture thereof.

Examples of further plasticizers are
the monoalkyl esters of benzoic acid, e.g. isononyl benzoate,
the benzoic diesters of mono-, di-, tri- or polyalkylene glycols, e.g. propylene glycol dibenzoate, diethylene glycol dibenzoate, dipropylene glycol dibenzoate, triethylene glycol dibenzoate or polyethylene glycol dibenzoate and in particular mixtures thereof,
the dialkyl esters of aliphatic diacids, e.g. di(2-ethylhexyl) adipate, diisononyl adipate, di(2-ethylhexyl) sebacate, di(2-ethylhexyl) azelate, diisononyl cyclohexane-1,2-dicarboxylate
the dialkyl esters of aromatic diacids, e.g. di(2-ethylhexyl) phthalate, diisononyl phthalate, diisodecyl phthalate, benzyl butyl phthalate, benzyl isooctyl phthalate, benzyl isononyl phthalate,
the trialkyl esters of aromatic triacids, e.g. trioctyl trimellitate, the phenyl esters of alkanesulphonic acids, e.g. the product Mesamoll® from LANXESS Deutschland GmbH,
the alkyl or aryl esters of phosphoric acid, e.g. tri(2-ethylhexyl) phosphate, diphenyl 2-ethylhexyl phosphate, diphenyl cresyl phosphate or tricresyl phosphate, polyesters which can be prepared by way of example from dicarboxylic acids, such as adipic acid or phthalic acid and from diols such as 1,2-propanediol, 1,3-butanediol, 1,4-butanediol or 1,6-hexanediol.

For the purposes of the invention, the inventive ester mixtures can also be used in mixtures which comprise further plastics selected from the group consisting of homo- and copolymers based on ethylene, on propylene, on butadiene, on vinyl acetate, on glycidyl acrylate, on glycidyl methacrylate, on acrylates and methacrylates having alcohol components of branched or unbranched C₁-C₁₀ alcohols, styrene or acrylonitrile. Examples that may be mentioned are polyacrylates having identical or different alcohol radicals from the group of the C₄-C₈ alcohols, particularly of butanol, of hexanol, of octanol and of 2-ethylhexanol, polymethyl methacrylate, methyl methacrylate-butyl acrylate copolymers, methyl methacrylate-butyl methacrylate copolymers, ethylene-vinyl acetate copolymers, chlorinated polyethylene, nitrile rubber, acrylonitrile-butadiene-styrene copolymers, ethylene-propylene copolymers, ethylene-propylene-diene copolymers, styrene-acrylonitrile copolymers, acrylonitrile-butadiene rubber, styrene-butadiene elastomers and methyl methacrylate-styrene-butadiene copolymers.

The mixtures prepared with the inventive ester mixtures are by way of example useful for production of pipelines, of cables, of wire sheathing, in the fitting-out of interiors, in the construction of vehicles and of furniture, in floor coverings, in medical items, in food-or-drink packaging, in gaskets, in foils, in composite foils, in foils for laminated safety glass, in particular for the vehicle sector and the architectural sector, in synthetic leather, in toys, in packaging containers, in adhesive-tape foils, in clothing, in coatings, and also in fibres for wovens.

The inventive ester mixtures have good processability due to their low solution temperatures and have low volatility.

The plasticizers and the processes of this invention are illustrated via the examples below, which do not restrict the scope of the invention. [data in percentage by area].

### EXAMPLES

### Determination of Solution Temperature

To determine solution temperature, 48 g of the plasticizers to be tested were mixed with 2 g of Vinnol® H70 polyvinyl chloride, grain size <315 μm, and 2 drops of Irgastab® 17 M in a glass beaker. The suspension was heated at from 2 to 3° C. per minute, with stirring, until a temperature has been reached at which for 3 minutes in succession there is no further observable rise in the value indicated by a photocell positioned behind the glass beaker and the polyvinyl chloride has dissolved.

### Determination of Volatility

The measure used for volatility comprised the amount of condensable constituents determined as follows. 10 g of the plasticizer here are placed in a thermostatically controlled cylindrical vessel (fogging test apparatus N8-FPG). The condensation surfaces used comprise a cooled aluminium foil whose weight was determined in advance. The sealed cylinder is then heated to 100° C. for 16 h. The aluminium foil is then removed. After 4 h of storage in a desiccator, the increase in weight is determined via difference weighing. Two determinations of volatility are carried out.

### Examples 1 to 5

### Preparation of Ester Mixtures

Benzyl chloride, n-butanol, triethylamine and anhydrous sodium carbonate were used as initial charge under nitrogen in a 2000 ml four-necked round-bottomed flask with reflux condenser, internal thermometer, and stirrer with precision glass gland. The reaction mixture was then heated to 90° C., and portions of trimellitic anhydride were added within a period of 3.5 h. Initially, large amounts of gas were evolved when the portions of trimellitic acid were added. The mixture was then stirred at 90° C. for 8 h. Three water-washes at 80° C. were then carried out (water/organic phase: 1/1). The organic phase was the top phase in the first of the washes, but the bottom phase in the subsequent washes. Steam distillation was then carried out until the amount of condensate collected was twice the volume of crude organic product. Finally, the product was dried at 140° C. and 4 mbar on a rotary evaporator. This gave a colourless viscose liquid. The table below gives constitution and yields.

TABLE 1

| | Example | | | | |
|---|---|---|---|---|---|
| | 1 | 2 | 3 | 4 | 5 |
| n-BuOH (mol) | 1.08 | 1.05 | 1.10 | 1.20 | 1.20 |
| Benzyl chloride (mol) | 2.20 | 2.20 | 2.05 | 2.05 | 2.05 |
| Na₂CO₃ (mol) | 1.33 | 1.33 | 1.33 | 1.33 | 1.33 |
| Net₃ (mol %, based on | 0.04 | 0.04 | 0.07 | 0.07 | 0.06 |
| TMA) | | | | | |
| Acid number | <0.1 | <0.1 | <0.1 | <0.1 | <0.1 |
| [mgKOH/g] | | | | | |
| Yield [%] | 75 | 73 | n.d. | 75 | 82 |
| Constitution % | | | | | |
| Tributyl trimellitate | 0 | 0 | 0 | 0 | 0 |
| Dibutyl benzyl | 1.9 | 1.9 | 0.8 | 3.7 | 2.4 |
| trimellitate | | | | | |
| Monobutyl dibenzyl | 89.6 | 75.7 | 85.0 | 79.3 | 83.2 |
| trimellitate | | | | | |
| Tribenzyl trimellitate | 6.9 | 18.5 | 11.2 | 11.9 | 8.4 |

n.d.: not determined;
TMA: trimellitic anhydride; constitution in GC %.

Properties of Ester Mixture from Example 1

TABLE 2

| | | | Pour | |
|---|---|---|---|---|
| | Solution | Viscosity | point | Condensate |
| Example | temperature (° C.) | (mPas) | (° C.) | (mg) |
| 1 | 116 | 832 | −10 | 13 |
| Non-inventive: | | | | |
| Unimoll ® BB | 110 | 62 | −40 | 36 |
| Uraplast ® 525 | 160 | 114 | −43 | 0.13 |

Unimoll ® BB: Benzyl butyl phthalate;
Uraplast ® 525: C₈-C₁₀-trialkyl trimellitate derived from linear C₈-C₁₀ alcohols.

From the examples, it can be readily seen that the process described permits preparation of the inventive plasticizers in high yields while avoiding stoichiometric amounts of tertiary amines. The solution temperature of the inventive plasticizers is lower than the solution temperature of corresponding pure trialkyl trimellitates and comparable with that of commercial benzyl alkyl phthalates. At the same time, the inventive plasticizers exhibit lower volatility than corresponding commercial benzyl alkyl phthalates.

What is claimed is:

1. An ester mixture comprising
a) from 80 to 99% by weight of one or more esters of the structure (R¹OOC)ₙ-Z-(COOR²)ₚ
b) from 1 to 20% by weight of an ester of the structure (R²OOC)ₘ-Z
where the total of the % by weight values derived from the components of the ester mixtures is 100
and
wherein
R¹ is a straight-chain or branched C₁-C₂₀-alkyl moiety,
R² is a benzyl moiety optionally substituted with C₁-C₄-alkyl or with halogen,
Z is an m-valent aromatic C₆-C₁₀-hydrocarbon moiety,
m is a number from 3 to 4 and each of n and p is a number from 1 to 3, with the proviso that n+p=m.

2. An ester mixture according to claim 1, wherein R² is benzyl.

3. An ester mixture according to claim 1 and/or 2, wherein R¹ is n-butyl, 2-ethylhexyl or isononyl.

4. An ester mixture according to claim 1, wherein the esters of the structure (R¹OOC)ₙ-Z-(COOR²)ₚ are benzyl dibutyl trimellitate and dibenzyl butyl trimellitate and the ester of the structure (R²OOC)ₘ-Z is tribenzyl trimellitate.

5. A process for preparation of ester mixtures comprising
a) from 80 to 99% by weight of one or more esters of the structure (R¹OOC)ₙ-Z-(COOR²)ₚ
b) from 1 to 20% by weight of an ester of the structure (R²OOC)ₘ-Z
where the total of the % by weight values derived from the components of the ester mixtures is 100
and
wherein
R¹ is a straight-chain or branched C₁-C₂₀-alkyl moiety,
R² is a benzyl moiety optionally substituted with C₁-C₄-alkyl or with halogen,
Z is an m-valent aromatic C₆-C₁₀-hydrocarbon moiety,
m is a number from 3 to 4 and
each of n and p is a number from 1 to 3, with the proviso that n+p=m,
by reacting at least one aromatic tri- or tetrabasic polycarboxylic acid or a derivative thereof, at least one benzyl halide and at least one aliphatic alcohol with one another at temperatures of from 50 to 300° C. and at pressures of from 2 mbar to 10 bar in the presence of an inorganic base and of a substoichiometric amount of a phase-transfer catalyst.

6. A process according to claim 5, wherein polycarboxylic acids or their derivatives selected from the group consisting of pyromellitic acid or trimellitic acid are used.

7. A process according to claim 6, wherein the anhydrides are used as derivatives.

8. A process according to claim 5, wherein unsubstituted benzyl chloride and, as aliphatic alcohol n-butanol, 2-ethylhexanol or isononanol are used.

9. A method of using the ester mixtures according to claim 1 as plasticizers for plastics.

10. A method of use according to claim 9, wherein the plastics are polyvinyl chloride, vinyl-chloride-based copolymers, polyvinylidene chloride, polyvinyl acetals, polyacrylates, polyamides, polylactides, cellulose and its derivatives or rubber polymers, preferably acrylonitrile-butadiene rubber, hydrogenated acrylonitrile-butadiene rubber, chloroprene rubber, chlorinated polyethylene, chlorosulphonyl polyethylene, ethylene-propylene rubber, acrylate rubber and/or epichlorohydrin rubber.

11. A method of use of the ester mixtures according to claim 9, wherein the plastics comprise additives from the group of lubricants, fillers, pigments, flame retardants, light stabilizers and other stabilizers, blowing agents, polymeric processing aids, impact modifiers, optical brighteners, and antistatic agents, and/or biostabilizers, or else a mixture thereof.

12. A method of use of the ester mixtures according to claim 11, characterized in that the plastics also comprise further plasticizers, preferably monoalkyl esters of benzoic acid, benzoic diesters of mono-, di-, tri- or polyalkylene glycols, dialkyl esters of aliphatic diacids, dialkyl esters of aromatic diacids, trialkyl esters of aromatic triacids, phenyl esters of alkanesulphonic acids, alkyl or aryl esters of phosphoric acid, polyesters derived from dicarboxylic acids, or else a mixture thereof.
